(19) United States
(12) Patent Application Publication
(10) Pub. No.: US 2026/0201161 A1
(43) Pub. Date: Jul. 16, 2026

(54) DISPENSING DEVICE COMPRISING A POLYESTER COMPOSITION

(71) Applicant: APTAR FRANCE SAS, Le Neubourg (FR)

(72) Inventors: Héloïse BLACHE, Rouen (FR); Patrice LÉONÉ, Acquigny (FR)

(73) Assignee: APTAR FRANCE SAS, Le Neubourg (FR)

(21) Appl. No.: 19/131,665

(22) PCT Filed: Nov. 21, 2023
(86) PCT No.: PCT/FR2023/051829

§ 371 Date: May 21, 2025

(30) Foreign Application Priority Data
Nov. 22, 2022 (FR) FR2212160

(51) Int. Cl. C08L 67/02; B65D 25/38

(52) U.S. Cl. CPC C08L 67/02; B65D 25/38

(57) ABSTRACT

The dispensing device having a polyester composition having essentially a mixture of components A and B which are defined as follows: A: a copolyether ester elastomer (COPE) having essentially hard segments of polyester and soft segments of aliphatic polyether and having a hardness of less than 50 Shore D, and B: a polyethylene terephthalate (PET) or a copolyester, or a mixture of both.

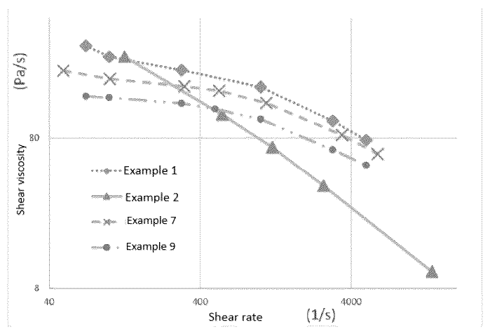

### TECHNICAL FIELD

The present invention uses a polyester composition based on polyethylene terephthalate (PET) or the like, instead of polyolefins (polyethylene (PE) or polypropylene (PP)), for the manufacture of dispensing devices for the packaging industry which are intended to be mounted on bottles, tubes and jars intended for the packaging industry. Advantageous fields of use are the fields of food, cleaning products, personal care, pharmacy and cosmetics.

### CONTEXT OF THE INVENTION

The circular economy for plastic packaging gives rise to the need to design single-material packaging systems, i.e. in which the different components consist of compatible polymer materials or materials from the same chemical family, in order to optimise their recycling. To date, the majority of stoppers and dispensing devices on the market which are intended to be used on PET containers, for instance bottles, tubes or pots, either consist of multi-material components or single-material components based on polyolefins such as polyethylene or polypropylene. To our knowledge, to date, no polyester-based single-material dispensing device intended for PET containers has yet been described in the literature.

### Description of PET

Polyethylene terephthalate or PET is a semi-crystalline thermoplastic polyester obtained by polycondensation of two monomers, terephthalic acid and ethylene glycol, as shown in formula 1 below. Its main properties are impermeability to gases and liquids, chemical resistance, rigidity and transparency.

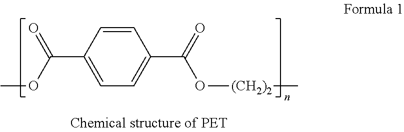

PET is commonly used in various fields of use: packaging (bottles of water and carbonated beverages, fruit trays, bottles for cosmetic products, etc.), automotive (car door handles, interior trim elements, air vents), electronics (sockets, lamp holders, fuse boxes). In addition to the properties mentioned above, PET is currently the most recycled plastic and is therefore a good candidate for the circular economy.

Comparison with Other Polymers

Table 1 below compares the properties of PET to those of other polymers such as polypropylene or polyethylene and ABS.

TABLE 1
Comparison of the mechanical properties of the
types of plastic used in the packaging industry

| | | | | | Acrylonitrile |
|---|---|---|---|---|---|
| | | Polyethylenes | | High-density | butadiene |
| | | terephthalate | Polypropylene | polyethylene | styrene |
| Properties | Units | (PET) | (PP) | (HDPE) | (ABS) |
| PHYSICAL | | | | | |
| Density | | 1.38 | 0.9 | 0.95 | 1.05 |
| Permeability | mL · | 10 to 100 | >1000 | >1000 | No data |
| to O₂ | m²/day | | | | |
| (at 1 atm, | | | | | |
| 20° C.) | | | | | |
| Water | % | 0.1-0.2 | 0.01-0.1 | 0.005-0.01 | 0.2-0.6 |
| absorption | | | | | |
| (24 h) | | | | | |
| MECHANICAL | | | | | |
| Hardness | Shore D | 83 | 67-74 | 63-67 | 75 |
| Tensile | MPa | 2300-2800 | 1000-1600 | 500-1100 | 1600-2600 |
| modulus | | | | | |
| Charpy | kJ/m² | 3 | 4-20 | 4 | 20 |
| impact | | | | | |
| strength | | | | | |
| (notched) | | | | | |

Compared to polyolefins (PP or PE), PET has the following advantages:
Gas barrier properties
Good chemical and thermal resistance

In addition to the advantages mentioned above, it has other advantages, but also some disadvantages which are summarised in Table 2 below:

TABLE 2
Advantages and limitations of PET compared to PP
PET compared to PP (advantages and disadvantages)

| Advantages | Disadvantages |
|---|---|
| More organised and | Very different |
| efficient recycling | mechanical |
| streams | properties: Twice as |
| Food-safe grades | rigid as PP |
| Good gas barrier | More complicated |
| properties | injection moulding |
| Good thermal and | process (preliminary |
| chemical resistance | drying step, etc.) |
| | Sensitivity to |
| | hydrolysis and |
| | degradation at high |
| | temperature |

Despite its beneficial properties and positive effect in the circular economy, it is clear that pure PET could not be used as a replacement for polyolefins, as illustrated in Table 1.

It is an object of the present invention to provide novel thermoplastic compositions which are intended mainly for, but are not limited to, injection moulding, and which have lower hardness, a lower tensile modulus, a higher impact strength, and a lower melt viscosity compared to pure PET, and in which these properties are similar to those of PP while retaining the ability to recycle the PET obtained using the usual PET recycling streams. Another object of the present invention is to provide a panel of polyester material formulations from which a material can be selected, the properties of which can be adapted to the needs of the design and manufacture of components for dispensing devices for the packaging industry, which are specifically intended for use on containers distributed by the packaging industry and which can be produced based on PET or copolyester.

### SUMMARY OF THE OBJECTS AND OF THE INVENTION

In order to fulfil these objects, the present invention proposes a dispensing device that is intended to be mounted on a container to form a dispenser for a fluid product, the dispensing device consisting essentially of a polyester composition consisting essentially of a mixture of components A and B which are defined as follows:
A: a copolyether ester elastomer (COPE) consisting essentially of hard segments of polyester and soft segments of aliphatic polyether and having a hardness of less than 50 Shore D, and
B: a polyethylene terephthalate (PET) or a copolyester, or a mixture of both.

The invention thus defines a dispensing device, such as a stopper, an applicator, or more generally a one-piece dispensing device, that is intended to be mounted on or associated with a polyester container to form a dispenser for a fluid product, the dispensing device essentially consisting of the polyester composition defined above, which essentially consists of A and B.

A fluid product is defined here as any substance that can flow, and therefore includes products in liquid form, and powdered or granular solids.

The present invention also proposes a dispensing device that is intended to be mounted on a container to form a dispenser for a fluid product, the dispensing device being free from polyolefin and comprising a plurality of elements, at least one element consisting essentially of a polyester composition consisting essentially of a mixture of components A and B which are defined as follows:
A: a copolyether ester elastomer (COPE) consisting essentially of hard segments of polyester and soft segments of aliphatic polyether and having a hardness of less than 50 Shore D, and
B: a polyethylene terephthalate (PET) or a copolyester, or a mixture of both, all the other elements being made from component A or B.

The invention thus defines a multi-element dispensing device, such as a pump or a valve, that is intended to be mounted on or associated with a polyester container to form a dispenser for a fluid product, the dispensing device being free from polyolefin, at least one element essentially consisting of the polyester composition defined above, which essentially consists of A and B, and all the other elements being made from component A or B.

The presence of functional additives is not excluded in the polyester composition, which, in all cases, still essentially consists of A and B.

Advantageously, the copolyester is obtained by polymerising at least one acid selected from terephthalic acid, 2,5-furandicarboxylic acid or isophthalic acid with an alcohol selected from ethylene glycol, cyclohexanedimethanol, trimethylene glycol and isosorbide by recycling a polymer composed of these monomers.

The copolyester can be glycol-modified polyethylene terephthalate (PETG).

The copolyester can also be selected from glycol-modified polycyclohexylene dimethylene terephthalate (PCTG), acid-modified polycyclohexylene dimethylene terephthalate (PCTA), polyethylene-co-isosorbide terephthalate (PEIT), and polyethylene furanoate (PEF). Mixtures of a plurality of copolyesters from PETG, PCTG, PCTA, PEIT and PEF can be envisaged. It is also possible to envisage the use of a raw material which is “recycled” by a mechanical or chemical process and which corresponds to the characteristics mentioned above.

According to another characteristic of the invention, component A is present in a weight ratio of 0.5% to 40%, advantageously 1% to 30%, and preferably 5% to 15%, and component B is present in a weight ratio of 60% to 99.5%, advantageously 70% to 99%, and preferably 85% to 95%.

According to another aspect of the invention, the hard segment of polyester in component A can consist of butylene terephthalate units. It is also possible to envisage replacing butylene terephthalate with ethylene terephthalate without departing from the scope of the invention.

The composition obtained by adding the elastomer (COPE) to the polyester matrix (PET or similar) will have a lower tensile modulus, a lower hardness, an improved impact strength and a better melt viscosity compared to a pure polyester matrix (PET for example) or compared to polypropylene, which will make it better suited to implementation in particular by injection moulding, without being limited thereto, and to the designs of dispensing systems that are intended to be used on polyester containers, which may also originate from a recycling stream.

The invention further defines a dispenser for a fluid product, comprising a one-piece or multi-element dispensing device as defined above.

Advantageously, the dispenser for a fluid product comprises a container made from component B, on which the dispensing device is mounted to dispense the fluid product contained in the container. Alternatively, the container can be made of polyester or polyolefin. Alternatively, it can also be made of glass, metal, ceramic, etc.

[Single FIGURE] The single FIGURE is a graph showing the curves of the shear-thinning behaviour measured by capillary rheometer at 275° C. for samples 1, 4 and 9, and at 205° C. for sample 2.

### DETAILED DESCRIPTION

The present invention relates to a polyester composition which can be used in a suitable shaping process for plastics, for example in injection moulding. Preliminary mixing by means of a compounding or extrusion unit may or may not be carried out before using the polyester mixture in an injection press, a process for injection blow moulding, extrusion, extrusion blow moulding, calendering or thermoforming, or any means suitable for converting and processing polymers. Suitable drying at a rate of less than 0.05% by weight will preferably be carried out before any high-temperature treatment of the polyester materials. The main polyester matrix will be a polyethylene terephthalate (PET) or a copolyester obtained by the polymerization of terephthalic acid, 2,5-furandicarboxylic acid or isophthalic acid with ethylene glycol, cyclohexanedimethanol, trimethylene glycol or isosorbide. Such copolyesters comprise materials that are known to those skilled in the art by their acronyms: PETG, PCTG, PCTA, PEIT, PEF, etc. Such polyesters can be used for the manufacture of containers, bottles, tubes and pots that are generally intended for mass distribution and the packaging industry. This polyester matrix may also originate from a recycling stream, with the chemical composition thereof always meeting the abovementioned criteria.

An elastomer from one of the families described below will be mixed with the main polyester matrix in an amount of between 0.5 and 40% by weight, advantageously between 1% and 30% and preferably from 5% to 15%. This elastomer preferably has a Shore D hardness of less than 50 units, and belongs to the family of polyester-ether elastomers (COPE), which are thermoplastic copolymeric elastomers for which the building blocks are linked together by ester chemical bonds and which are formed of two microstructural phases:
Rigid phase (ester-based rigid segments): Polymer in crystalline form, ensuring the cohesion and strength of the material. The rigid phase of COPE will commonly be PBT (polybutylene terephthalate), but may also be hard segments of PET (polyethylene terephthalate).
Flexible phase (ether-based flexible segments): Polymer in the rubbery state that gives the material its elastomeric nature, commonly a polyether glycol such as, without being limited to, polytetramethylene ether glycol (PTMEG) or polyethylene glycol.

It should be noted that COPE can be replaced, depending on the type of application and the desired properties, by one of the following three chemical families:

### 1) Thermoplastic Polyurethane (TPU) Elastomers

TPUs have a microstructure similar to that of COPE. They are materials in which the bonds between the building blocks are urethane bonds and which are formed of two microstructural phases:
Rigid phase (polyurethane-based rigid segment): Polymer in crystalline form, ensuring the cohesion and strength of the material. The rigid phase of TPU is commonly, but not exclusively, composed of methylene diisocyanate (MDI) or toluene diisocyanate (TDI) associated with a chain-extending diol molecule which is commonly, but not exclusively, butanediol (BDO).
Flexible phase (ether-based or polyester-based flexible segment): Polymer in the rubbery state that gives the material its elastomeric nature, which may be a polyether glycol such as, without being limited to, PTMEG (polytetramethylene ether glycol), or a macrodiol based on aliphatic polyester such as, without being limited to, polycaprolactone or polybutylene succinate (PBS).

### 2) Polyether Amide Elastomers (COPA)

COPA are thermoplastic copolymeric elastomers in which the bonds between the building blocks are amide bonds and which are formed of two microstructural phases:
Rigid phase (polyamide-based rigid segment): Polymer in crystalline form, ensuring the cohesion and strength of the material. The rigid phase of COPA is commonly polyamide 12, which is obtained, non-limitingly, by polycondensation of aminolauric acid or ring opening of laurolactam.
Flexible phase (ether-based flexible segment): Polymer in the rubbery state that gives the material its elastomeric nature, which may be, but is not limited to, a polyether glycol such as PTMEG (polytetramethylene ether glycol).

### 3) Glycols, Also Referred to as Aliphatic Polyethers

Polyethylene glycol (PEG) or polytetrahydrofuran (PTMEG) are flexible molecules having the following chemical structure:

### Example of Chemical Structure of Glycols (in this Case, Polyethylene Glycol)

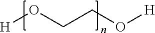

Preference will be given to using products in the mixture which have an average molar mass of at least 4000 g/mol, in order to minimise migration into the products that the dispenser contains.

### Examples

### Test Procedures

Implementation: The raw material formulations were first mixed in the form of granules in the suitable proportions and were then dried for 6 h at 120° C. before any high-temperature conversion processes were carried out. The dried granule mixtures were then either injection moulded to form dumbbell-shaped samples in order to perform mechanical tests, or were mixed by an extruder and converted into granules in order to perform rheological tests.

Density measurement: The density was measured according to the instructions of method A of standard ISO 1183, using scales equipped with a metal wire density measurement kit.

Mechanical tests: According to standard ISO 527, A1 dumbbells were used to measure the tensile properties of the different examples presented below, obtained using a pulling speed of 50 mm/min. The impact strength values were obtained according to standard ISO 179. The hardness values were obtained according to the ISO 868 procedure.

Rheological test: The curves for melt viscosity as a function of shear rate were obtained using a capillary rheometer, and were measured at a temperature of 275° C. All the samples in the form of granules were dried at 120° C. for 6 h before the measurement.

### Results

Example 1: In this example, a control sample consisting of 100% PET, resulting from the polymerisation of terephthalic acid and ethylene glycol, with an IV viscosity of 0.8 dL/g, which is considered “bottle grade” by the packaging industry, was dried for 6 h at 120° C. before being injection moulded into A1 dumbbell shapes for the mechanical tests. The dried granules of this material were also mixed by means of an extruder to obtain treated granules. This example has been included in the present document solely for the purpose comparison with the following examples. The mechanical properties and the curve of shear-thinning behaviour in the melt state can be found in Table 3 and the graph below.

Example 2: In this example, a control sample consisting of 100% polypropylene copolymer having a melt flow index considered to be of “injection quality”, which is suitable for the injection of bottle caps and closures by the packaging industry, was injection moulded into A1 dumbbell-shaped samples for mechanical tests. Granules of this material were also mixed by means of an extruder to obtain conditioned granules. This example has been included in the present document solely for the purpose comparison with the following examples. The mechanical properties and the curve of shear-thinning behaviour in the melt state can be found in Table 3 and the graph below. The mechanical properties and melt viscosity are very different from those of Example 1, illustrating the gap between the two materials that this invention aims to overcome.

Examples 3 to 6: In these examples, mixtures of granules of a PET having an IV viscosity of 0.8 dL/g (considered to be “bottle grade” by those skilled in the art) and of a COPE having a Shore D hardness of 25 (an example of such a product is Riteflex 425 from Celanese), referred to as COPE1 in Table 3 below, at a ratio ranging from 1 to 30% by weight, as indicated in Table 3, were produced. The granule mixtures were then dried for 6 h at 120° C., before being injection moulded into A1 dumbbell-shaped samples for the mechanical tests. The mixtures of dried granules were also mixed by means of an extruder to obtain treated granules. The mechanical properties are indicated in Table 3 below. Increasing the amount of COPE in the samples makes it possible to adjust the mechanical properties of the material and, in the case of Example 6, to come close to the properties of Example 2 while obtaining better impact strength than Examples 1 and 2. Furthermore, Example 3 has significantly improved impact strength compared to Examples 1 and 2, without significantly modifying the other mechanical properties. Examples 4 to 5 demonstrate a significant decrease in flexural modulus and hardness, even though the amount of COPE added remains less than 15%. Examples 3 to 5 therefore illustrate the possibility of choosing the composition of the polyester mixture according to the requirements of the application.

Example 7: In this example, a mixture of granules of a PET having an IV viscosity of 0.8 dL/g (considered to be “bottle grade” by those skilled in the art) and of a COPE having a Shore D hardness of 40 (an example of such a product is “Riteflex 640A” from Celanese), referred to as COPE2 in Table 3 below, at a ratio of 5% by weight, as indicated in Table 3, was produced. The granule mixtures were then dried for 6 h at 120° C., before being injection moulded into A1 dumbbell-shaped samples for the mechanical tests. The mechanical properties and the curve of shear-thinning behaviour in the melt state can be found in Table 3 and the graph below. This example has properties similar to those of Example 4, while maintaining an impact strength which is comparable to that of Examples 1 and 2, making it of use in applications where lower impact strength is required. The flexural properties of Example 7 are similar to those of Example 4, with lower impact strength than Examples 1 and 2. These properties could be of interest in applications of polyester devices with an anti-intrusion function. This example also has a lower melt viscosity than Example 1, making it easier to process by injection moulding, particularly in the case of thin-walled components.

Example 8: In this example, a mixture of granules of a PET having an IV viscosity of 0.8 dL/g (considered to be “bottle grade” by those skilled in the art) and of flakes of a polytetrahydrofuran product (PTMEG—an example of this product is “Carbowax PEG 8000” from Dow Chemical Company) having a molecular weight of 8000 g/mol, at a ratio of 5% by weight, as indicated in Table 3 below, was produced. The granule mixture was then dried for 6 h at 120° C., before being injection moulded into A1 dumbbell samples for the mechanical tests. The mechanical properties are indicated in Table 3 below. This example does not show the modification of the properties displayed by the previous examples, and proves that a two-phase elastomer is necessary to achieve the desired results. However, the addition of 5% PTMEG to a PET matrix resulted in the appearance of a behaviour of softening the tensile strain that is not observed in Examples 1 to 7 and that could be used on functional components that operate under higher strain rates, such as living hinges or film-type hinges.

Example 9: In this example, a mixture of granules of a PET having an IV viscosity of 0.8 dL/g (considered to be “bottle grade” by those skilled in the art) and of a TPU polyurethane elastomer having a Shore A hardness of 71 (an example of such a product is “Elastollan 1170 A 10 FC” from BASF), at a ratio of 5% by weight, as indicated in Table 3 below, was produced. The granule mixtures were then dried for 6 h at 120° C., before being injection moulded into A1 dumbbell samples for the mechanical tests.

In Examples 8 and 9, COPE (1 or 2) was replaced by PTMEG and TPU, respectively. It should be noted that protection could be sought for such a polyester composition resulting from the mixture of PET (or similar) and PTMEG or TPU. A composition mixing PET (or similar) and a plurality of components from COPE, PTMEG and TPU may also be envisaged. The mixtures of dried granules were also mixed by means of an extruder to obtain treated granules. The mechanical properties and the curve of shear-thinning behaviour in the melt state can be found in Table 3 and the graph below. This example showed a decrease in the flexural modulus comparable to Examples 4 and 7, and low impact strength. The melt viscosity is also significantly reduced, making it a very good candidate for processing by injection.

TABLE 3
Summary of the composition and mechanical properties of Examples 1 to 9

| Example number: | | | | | | | | |
|---|---|---|---|---|---|---|---|---|
| 1 | 2 | 3 | 4 | 5 | 6 | 7 | 8 | 9 |

Composition

| | |
|---|---|
| Materials | % by weight |

| | | | | | | | | | |
|---|---|---|---|---|---|---|---|---|---|
| PET | 100 | — | 99 | 95 | 85 | 70 | 95 | 95 | 95 |
| PP Copolymer | — | 100 | — | — | — | — | — | — | — |
| COPE 1 | — | — | 1 | 5 | 15 | 30 | — | — | — |
| COPE 2 | — | — | — | — | — | — | 5 | — | — |
| PTMEG | — | — | — | — | — | — | — | 5 | — |
| TPU | — | — | — | — | — | — | — | — | 5 |

Measurements

| Properties | Units | | | | | | | | | |
|---|---|---|---|---|---|---|---|---|---|---|
| Density | g/cm3 | 1.33 | 0.9 | 1.33 | 1.33 | 1.32 | 1.29 | 1.33 | 1.35 | 1.33 |
| Hardness | Shore D | 77 | 61 | 77 | 76 | 71 | 69 | 74 | 74 | 74 |
| Flexural | MPa | 2493 | 1300 | 2487 | 2224 | 1995 | 1489 | 2301 | 2465 | 2344 |
| Modulus | | | | | | | | | | |
| Impact | kJ/m² | 6.9 | 9.4 | 8.8 | 11 | 12.2 | 23.2 | 4.1 | 1.7 | 2.6 |
| resistance | | | | | | | | | | |
| (on notched | | | | | | | | | | |
| bar) | | | | | | | | | | |

1. A dispensing device that is intended to be mounted on a container to form a dispenser for a fluid product, the dispensing device consisting essentially of a polyester composition consisting essentially of a mixture of components A and B which are defined as follows:
A: a copolyether ester elastomer (COPE) consisting essentially of hard segments of polyester and soft segments of aliphatic polyether and having a hardness of less than 50 Shore D, and
B: a polyethylene terephthalate (PET) or a copolyester, or a mixture of both.

2. The dispensing device that is intended to be mounted on a container to form a dispenser for a fluid product, the dispensing device being free from polyolefin and comprising a plurality of elements, at least one element consisting essentially of a polyester composition consisting essentially of a mixture of components A and B which are defined as follows:
A: a copolyether ester elastomer (COPE) consisting essentially of hard segments of polyester and soft segments of aliphatic polyether and having a hardness of less than 50 Shore D, and
B: a polyethylene terephthalate (PET) or a copolyester, or a mixture of both, all the other elements being made from component A or B.

3. The dispensing device according to claim 1, wherein the copolyester is obtained by polymerising at least one acid selected from terephthalic acid, 2,5-furandicarboxylic acid or isophthalic acid with an alcohol selected from ethylene glycol, cyclohexanedimethanol, trimethylene glycol and isosorbide, or by recycling a polymer composed of these monomers.

4. The dispensing device according to claim 1, wherein the copolyester is glycol-modified polyethylene terephthalate (PETG).

5. The dispensing device according to claim 1, wherein the copolyester is selected from glycol-modified polycyclohexylene dimethylene terephthalate (PCTG), acid-modified polycyclohexylene dimethylene terephthalate (PCTA), polyethylene-co-isosorbide terephthalate (PEIT), and polyethylene furanoate (PEF).

6. The dispensing device according to claim 1, wherein component A is present in a weight ratio of 0.5% to 40%, advantageously 1% to 30%, and preferably 5% to 15%, and component B is present in a weight ratio of 60% to 99.5%, advantageously 70% to 99%, and preferably 85% to 95%.

7. The dispensing device according to claim 1, wherein the hard segment of polyester in component A consists of butylene terephthalate units.

8. The dispensing for a fluid product, comprising a dispensing device according to claim 1.

9. The dispensing for a fluid product according to claim 8, comprising a container made from component B, on which the dispensing device is mounted to dispense the fluid product contained in the container.

10. The dispensing according to claim 9, wherein the container is made from polyester, on which the dispensing device is mounted to dispense the fluid product contained in the container.

11. The dispensing for product according to claim 9, wherein the container is made from polyolefin, on which the dispensing device is mounted to dispense the fluid product contained in the container.
